(19) United States
(12) Patent Application Publication
(10) Pub. No.: US 2006/0167634 A1
(43) Pub. Date: Jul. 27, 2006

(54) Sensor network for aggregating data and data aggregation method

(75) Inventors: Sung-woo Cho, Seoul (KR); Nam-hyeong Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/219,644

(22) Filed: Sep. 7, 2005

(30) Foreign Application Priority Data
Nov. 26, 2004 (KR) 2004-98047

(51) Int. Cl. G01V 3/38

(52) U.S. Cl. 702/5

(57) ABSTRACT

A sensor network for aggregating data and data aggregation method. The sensor network includes a representative sensor node for collecting information in a predefined grid area that includes at least two sensor nodes, and transmitting the collected information of the predefined grid area; and a sink node for selecting the representative sensor node by randomly searching the sensor nodes in the predefined grid area and aggregating information of the predefined grid area from the selected representative sensor node. Accordingly, since the amount of the delivered data reduces and the overload is also lowered, the power consumption for the data transmission over the sensor network can be reduced. In addition, it is possible to control the data transmission rate depending on the correlation, and the quality of the delivered data can be enhanced.

### CROSS-REFERENCE TO RELATED APPLICATIONS

This application claims priority from Korean Patent Application No. 2004-98047 filed on Nov. 26, 2004 in the Korean Intellectual Property Office, the entire disclosure of which is incorporated herein by reference.

### BACKGROUND OF THE INVENTION

1. Field of The Invention

The present invention relates generally to a sensor network and a data aggregation method. More particularly, the present invention relates to a sensor network allowing a sink node to aggregate data from a sensor node in the sensor network that includes a sensor node transmitting data and a sink node receiving data, and a data aggregation method thereof.

2. Description of The Related Art

A typical mobile communication system delivers data between a mobile element and a base station. The mobile element and the base station directly transmit and receive data without the data passing through other mobile elements or nodes. On the other hand, in a sensor network, other sensor nodes are used to deliver data from a sensor node to a sink node.

Hereinafter, the structure of a conventional sensor network is explained in reference to FIG. 1. As illustrated in FIG. 1, the sensor network includes a sink node and a plurality of sensor nodes. Although FIG. 1 illustrates a sole sink node, the sensor network may include more than two sink nodes according to a user's setting.

The sensor nodes collect information relating to a target region defined by a user. The information relating to the target region can be a temperature, humidity, movement of an object, escape of gas, and the like.

The sensor nodes transmit to the sink node data of the collected information of the target region. The sink node receives the data from the sensor nodes over the sensor network. A sensor node, located away from the sink node within a certain distance, transmits the data directly to the sink node. A sensor node, outside of the certain distance from the sink node, transmits the collected data to sensor nodes in vicinity of the sink node rather than transmitting the data directly to the sink node.

The sensor node outside of the certain distance transmits the data via the neighbor sensor nodes in order to minimize the power consumption required for the data transmission. Primarily, the power consumption required for the data transmission from the sensor node to the sink node is proportional to the distance between the sink node and the sensor node.

Thus, the sensor node outside of the certain distance transfers the collected data via a plurality of sensor nodes to minimize the power consumption for the data transmission.

However, in the conventional sensor network where the sensor nodes collect and provide the information relating to the target region to the sink node, all of the sensor nodes within the target region transmit their collected data to the sink node. Hence, the sink node receives the data from every sensor node.

If there is little difference between current data and previous data, the sensor nodes send a short message without transmitting the current data to the sink node.

Since all of the sensor nodes within the target region transmit their collected data to the sink node, an overload is incurred. In addition, power may be wasted for the transmission of the data and the messages.

### SUMMARY OF THE INVENTION

The present invention provides a sensor network for aggregating and transmitting data by a selected representative sensor node in consideration of temporal and spatial correlation, and a data aggregation method of the representative sensor node.

The present invention also provides a sensor network for aggregating data with the reduced power consumption in consideration of correlation of the transmitted data, and a data aggregation method.

In accordance with an aspect of the present invention, there is provided a sensor network which includes a representative sensor node for collecting information in a predefined grid area that includes at least two sensor nodes, and transmitting the collected information of the predefined grid area; and a sink node for selecting the representative sensor node by randomly searching the sensor nodes in the predefined grid area and aggregating information of the predefined grid area from the selected representative sensor node.

The representative sensor node may be one of the at least two sensor nodes within the predefined grid area.

The representative sensor node may transmit the collected information of the predefined grid area to the sink node at a certain time interval, and the sensor nodes may transmit collected information of the grid area to the sink node at a time interval that is longer than the certain time interval.

The sink node may compute inaccuracy indicating a difference between the information received from the representative sensor node and the information received from the sensor nodes.

The sink node may redefine the grid area by comparing the computed inaccuracy with a preset upper limit.

The sink node may enlarge the predefined grid area when the computed inaccuracy is below the preset upper limit, and reduce a size of the predefined grid area when the computed inaccuracy is above the preset upper limit.

The sink node may reselect a representative sensor node by randomly searching sensor nodes disposed within the redefined grid area.

The sink node may reset the certain time interval by comparing a variance of the information of the predefined grid area, the information received from the representative sensor node at the certain time interval, with a threshold value which is a value of information transmitted from the representative sensor node at a previous time interval.

The sink node may lengthen the certain time interval when the variance of the information is below the threshold value, and shorten the certain time interval when the variance of the information is above the threshold value.

In accordance with another aspect of the present invention, there is provided a data aggregation method for a sensor network including sensor nodes for collecting information of a predefined grid area, a representative sensor node for transmitting the collected information of the predefined grid area to a sink node, and the sink node for aggregating the information from the representative sensor node, the method including defining a target region over the predefined grid area that covers at least two sensor nodes; selecting the representative sensor node by randomly searching the sensor nodes in the predefined grid area of the defined target region; and aggregating the information of the predefined grid area from the selected representative sensor node.

The representative sensor node may be one of the at least two sensor nodes within the predefined grid area.

The representative sensor node may transmit the collected information of the predefined grid area to the sink node at a certain time interval, and the sensor nodes may transmit collected information of the grid area to the sink node at a time interval that is longer than the certain time interval.

The data aggregation method may further include computing inaccuracy that indicates a difference between the information received from the representative sensor node and the information received from the sensor nodes.

The data aggregation method may further include redefining the grid area by comparing the computed inaccuracy with a preset upper limit.

The redefining of the predefined grid area enlarges the predefined grid area when the computed inaccuracy is below the preset upper limit, and reduces a size of the predefined grid area when the computed inaccuracy is above the preset upper limit.

The data aggregation method may further include reselecting a representative sensor node by randomly searching sensor nodes disposed within the redefined grid area after the predefined grid area is redefined.

The data aggregation method may further include resetting the certain time interval by comparing a variance of the information of the predefined grid area, the information received from the representative sensor node at the certain time interval, with a threshold value which is a value of information transmitted from the representative sensor node at a previous time interval.

The resetting of the certain time interval may lengthen the certain time interval when the variance of the information is below the threshold value, and shorten the certain time interval when the variance of the information is above the threshold value.

### BRIEF DESCRIPTION OF THE DRAWING FIGURES

The above and/or other aspects of the invention will become apparent and more readily appreciated from the following description of exemplary embodiments, taken in conjunction with the accompanying drawing figures of which:

FIG. 1 illustrates a conventional sensor network;

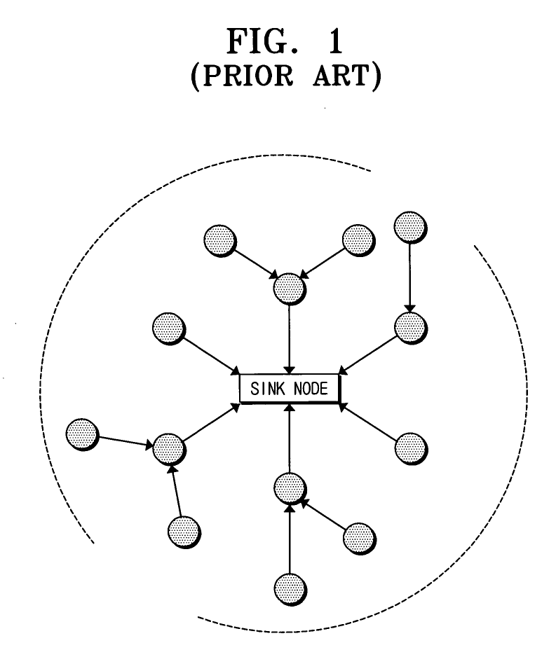

FIG. 2 illustrates a grid area, a target region, and a representative sensor node according to an exemplary embodiment of the present invention;

FIG. 3A illustrates a grid area redefined according to a data aggregation method;

FIG. 3B illustrates a grid area redefined according to the data aggregation method;

FIG. 4 is a flowchart explaining the data aggregation method according to an exemplary embodiment of the present invention; and

FIG. 5 is a flowchart explaining the data aggregation method according to an exemplary embodiment of the present invention.

### DETAILED DESCRIPTION OF EXEMPLARY EMBODIMENTS OF THE PRESENT INVENTION

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the drawings.

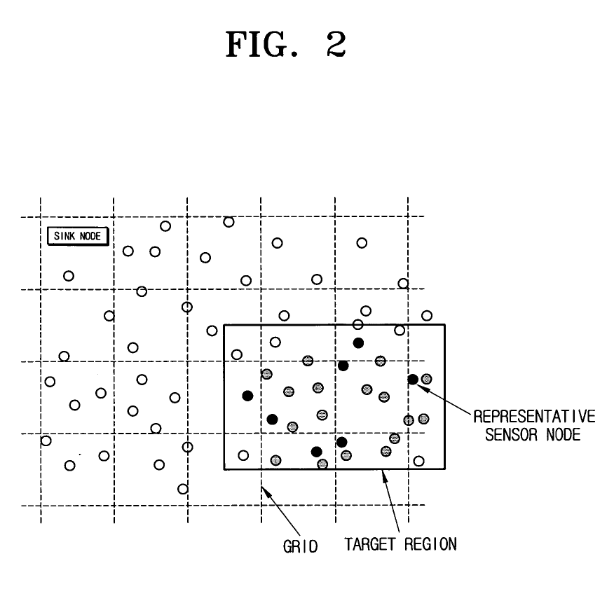

FIG. 2 illustrates a grid area, a target region, and a representative sensor node according to an exemplary embodiment of the present invention.

Referring to FIG. 2, a sensor network includes sensor nodes collecting information and a sink node receiving the collected information from the sensor nodes. The sensor network is partitioned by grids, and a target area is defined in the sensor network.

A designated user divides the sensor network area into a grid topology. The size of the grid area is defined by the designated user at the initial configuration. The target region where intended information is to be collected is defined by the designated user as well. When the grid area and the target region are defined, the sink node selects a representative sensor node that will transmit information collected from the grid areas within the target region. In specific, the sink node selects one representative sensor node in each grid area among the sensor nodes located in the target region. The sink node randomly searches the sensor nodes in a grid area to select one representative sensor node.

Although it has been described that the sink node randomly selects the representative sensor node from the sensor nodes in the grid area, the representative sensor node may be a sensor node in vicinity of the sink node according to location information provided from the sensor nodes. Also, the sink node may select a sensor node with the largest residual power as the representative sensor node among the sensor nodes in the grid area based on the residual power provided from the sensor nodes.

The representative sensor node of a grid area transmits the collected information of the grid area to the sink node on behalf of all the sensor nodes within its grid area. Since only the representative sensor node sends the information to the sink node, the energy consumption of the sensor nodes in the grid area reduces as the size of the grid area increases. Conversely, the more sensor nodes in the grid area, the higher energy consumption efficiency.

Alternatively, the representative sensor node of the grid area can transmit the collected information of the grid area to the sink node, and the other sensor nodes can also transmit the collected information to the sink node. Hereinafter, it is exemplified that the representative sensor node and the other sensor nodes transmit the collected information of the relevant grid area to the sink node.

Upon selecting the representative sensor node, the designated user determines a time interval of receiving the collected information of the target region. In more detail, the user determines a short time interval such that the representative sensor node can transmit the collected data with a high transmission rate. A long time interval enables the sensor nodes other than the representative sensor node in the target region to transmit the collected data with a low transmission rate.

TABLE 1

| | Representative sensor node | | Other sensor nodes | |
|---|---|---|---|---|
| Time | Measured | Transmission | Measured | Transmission |
| (T1) | value | value | value | value |
| 0 | 10 | 10 | 0.9 | 0.9 |
| 1 | 10.3 | 10.3 | 10.1 | No transmission |
| 2 | 10.5 | 10.5 | 10.4 | No transmission |
| — | — | — | — | — |
| N | 11.2 | 11.2 | 11.2 | 11.2 |
| N + 1 | 11.4 | 11.4 | 11.2 | No transmission |
| — | — | — | — | — |

In Table 1, the time interval of the representative sensor node is T1, and the time interval of the other sensor nodes is NT1. The representative sensor node transmits the measured value of a relevant grid area to the sink node at the time interval T1. The other sensor nodes transmit the measured value of the target region to the sink node at the time interval NT1, rather than constantly.

The sink node is able to control the size of the grid area and the transmission rate of the data using the spatial correlation and the temporal correlation. The sink node redefines the size of the grid area based on the spatial correlation and controls the data transmission rate based on the temporal correlation.

The following is an explanation of how the sink node redefines the size of the grid area based on the spatial correlation.

After certain time intervals, the sink node computes an inaccuracy based on the values transmitted from the representative sensor node and the other sensor nodes. The inaccuracy is a difference between the value transmitted from the representative sensor node of a relevant grid area and the values transmitted from the other sensor nodes in the relevant grid area. The inaccuracy can be obtained from Equation 1.

$$Inaccuracy = {\sum }_{k = cN}^{( c + 1 ) N - 1} {\sum }_{j = 1}^{M} \vert xj ( cN ) - X ( k ) \vert \qquad [ Equation 1 ]$$

In Equation 1, X is a data value provided from the representative sensor node of the grid area, xj is a data value provided from the other sensor nodes in the grid area, and M is the number of the other sensor nodes in the grid area.

X(k) is a data value transmitted from the representative sensor node at a time k (k=0, 1, 2, . . . ). xj(cN) is a data value transmitted from a j-th sensor node among the other sensor nodes at a time cN (c=0, 1, 2, . . . ). When the time interval of the other sensor nodes matches the time interval of the representative sensor node, the inaccuracy is obtained by subtracting the data value of the representative sensor node from the data values of the other sensor nodes and adding up the results of the subtraction.

If the inaccuracy is zero, the data value of the representative sensor node matches the data values of the other sensor nodes without the difference of the data values. The higher inaccuracy, the greater difference between the data value of the representative sensor node and the data values of the other sensor nodes, the lower data correlation. The lower inaccuracy, the smaller difference between the data value of the representative sensor node and the data values of the other sensor nodes, the higher data correlation.

The sink node compares the computed inaccuracy with an upper limit. The upper limit is a reference value to redefine the size of the grid area. The upper limit is set by the designated user.

The inaccuracy below the upper limit implies the small difference between the data value of the representative sensor node and the data values of the other sensor nodes, and the high data correlation. The higher correlation, the smaller difference between the data collected by the neighbor sensor nodes. Conversely, the inaccuracy over the upper limit implies the greater difference between the data value of the representative sensor node and the data values of the other sensor nodes, and the low data correlation. The lower correlation, the greater difference between the data collected by the neighbor sensor nodes.

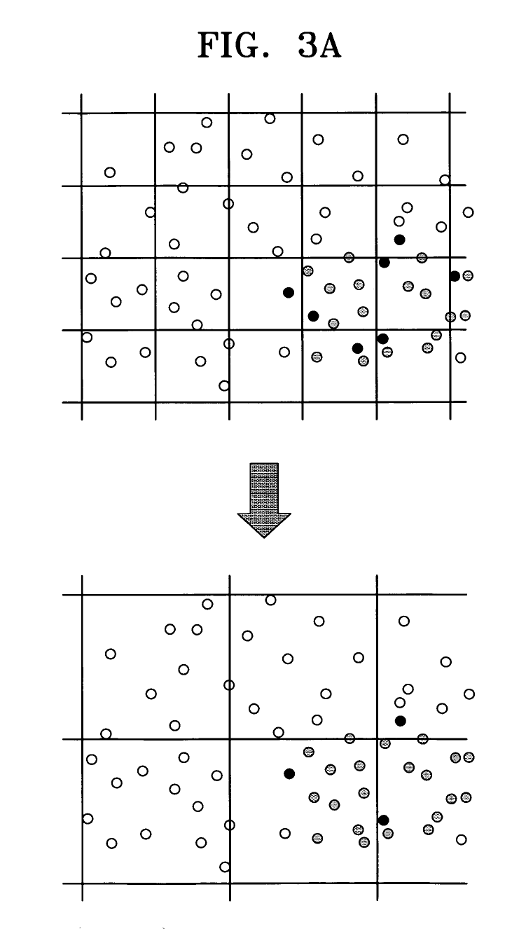

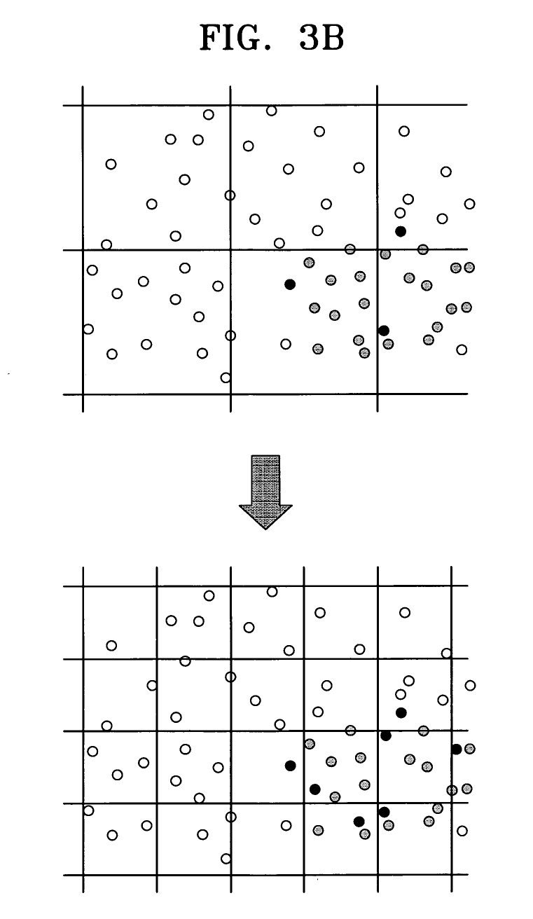

As such, the sink node compares the inaccuracy with the upper limit and redefines the prescribed grid area according to the comparison. FIG. 3A depicts an example of the redefined grid according the data aggregation method according to an exemplary embodiment of the present invention. In FIG. 3A, the size of the prescribed grid area is increased. Specifically, when the inaccuracy falls below the upper limit, the data aggregated from the sensor nodes has a high correlation. Thus, the sink node redefines the size of the grid area to be larger than the initial size of the grid area such that the redefined grid area can cover more other sensor nodes. After redefining the grid area, the sink node randomly searches the sensor nodes within the redefined grid area and reselects the representative sensor node.

FIG. 3B depicts another example of the redefined grid area according the data aggregation method according to an exemplary embodiment of the present invention. In FIG. 3B, the initial size of the grid area is decreased. Specifically, when the inaccuracy exceeds the upper limit, the data aggregated from the sensor nodes has a low correlation. Thus, the sink node redefines the size of the grid area to be smaller than the initial size of the grid area such that the redefined grid area can cover less other sensor nodes. After redefining the grid area, the sink node randomly searches the sensor nodes within the redefined grid area and reselects the representative sensor node.

Hereinafter, the description is provided on how the sink node controls the data transmission rate by means of the temporal correlation.

After the time intervals, the sink node computes variance of the data values transmitted from the representative sensor node. The variance of the data values is presented as a standard deviation. The sink node compares the obtained standard deviation with a threshold value. The threshold value is a certain value of the data value transmitted from the representative sensor node at the previous time interval. For instance, the threshold value may be set to 10% of the data value transmitted from the representative sensor node at the previous time interval.

The greater standard deviation, the greater difference between the data values transmitted from the representative sensor node, and the lower data correlation. Conversely, the smaller standard deviation, the smaller difference between the data values transmitted from the representative sensor node, the higher data correlation. Accordingly, the sink node compares the standard deviation with the threshold value and controls the transmission rate according to the comparison. When the standard deviation is below the threshold value, the sink node lowers the transmission rate of the representative sensor node since the data values provided from the representative sensor node has the high correlation. When the standard deviation is above the threshold value, the sink node raises the transmission rate of the representative sensor node since the data values provided from the representative sensor node has the low correlation.

TABLE 2

| | Time (T1) | | | | |
|---|---|---|---|---|---|
| | 0 | 1 | 2 | 3 | — |
| Measured value | 10 | 10.1 | 10.2 | 10.2 | — |
| Transmission | 10 | 10.1 | 10.2 | 10.2 | — |
| value | | | | | |

| | | |
|---|---|---|
| Transmission | 1 | — |
| rate (samples/T1) | | |

In Table 2, when the representative sensor node transmits to the sink node the data values measured for three time intervals at the time interval T1, the transmission rate is 1. An average of the data values transmitted from the representative sensor node to the sink node for the three time intervals is 10.125, and its standard deviation is 0. For example, if the threshold value be 10% of the data value transmitted from the representative sensor node at the previous time interval, then the threshold value is 1.02. Since the obtained standard deviation is below the threshold value, the data values from the representative sensor node have the high correlation. Thus, the sink node lowers the transmission rate of the representative sensor node.

The sink node may control the transmission interval depending on the variation of the data values provided from the representative sensor node. The sink node compares the data from the representative sensor node at a certain time interval. If there is a considerable variation of the received data, the sink node shortens the transmission interval. As for little variation of the data received from the representative sensor node at a certain interval, the sink node lengthens the transmission interval.

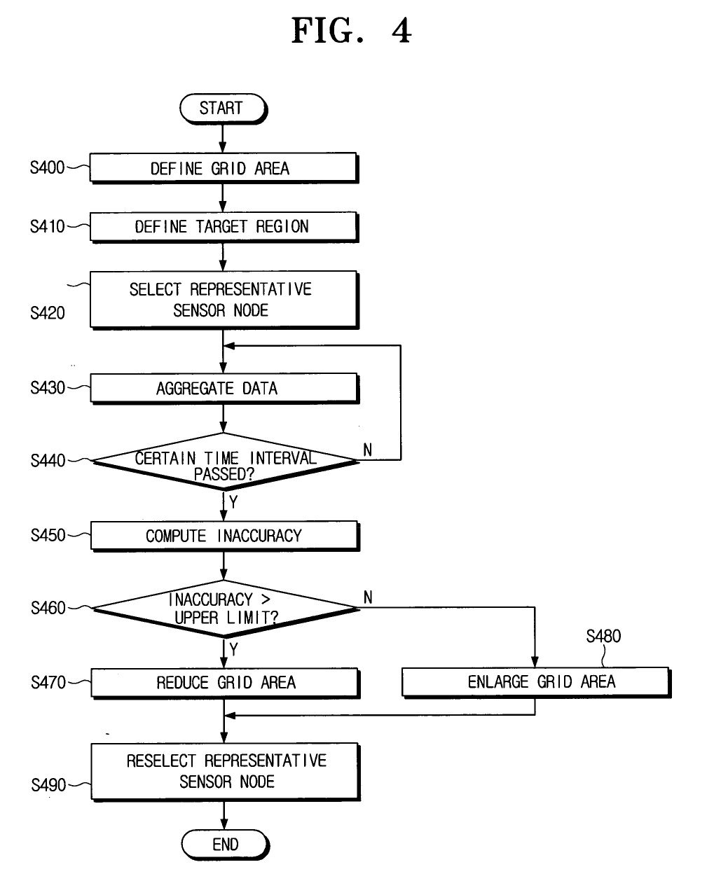

FIG. 4 is a flowchart explaining the data aggregation method according to an exemplary embodiment of the present invention.

Referring to FIG. 4, the designated user of the sensor network defines the grid area over the sensor network (S400). As the size of the grid area increases and the number of the sensor nodes disposed within the grid area increases, the power consumption of the sensor network can be reduced.

Upon defining the grid area, the designated user of the sensor network defines a target region where data is to be collected (S410).

Upon defining the target area, the sink node selects a representative sensor node that transmits the collected information of the grid areas covered by the target region (S420). The sink node randomly searches the sensor nodes in the grid areas to select a representative sensor node. One representative sensor node is present in one grid area and is responsible for the data collection in its grid areas and the data transmission to the sink node.

The sink node aggregates the data received from the representative sensor node and the other sensor nodes (S430). The representative sensor node and the other sensor nodes transmit their collected data within the grid areas to the sink node at prescribed time intervals, respectively. The representative sensor node transfers the data at short time intervals, and the other sensor nodes transfer the data at long time intervals.

The sink node determines whether a certain time interval is passed (S440). For the certain time interval, the sink node aggregates the data from the representative sensor node and the other sensor nodes.

After the certain time interval, the sink node computes the inaccuracy (S450). The inaccuracy is a difference between the value transmitted from the representative sensor node of a relevant grid area and the value transmitted from the other sensor nodes in the relevant grid area. The inaccuracy is obtained by subtracting the data value of the representative sensor node from the data values of the other sensor nodes and summing the results of the subtraction.

The sink node determines whether the computed inaccuracy is above a preset upper limit (S460). The upper limit is preset as a reference value to redefine the size of the grid area by the user.

When the computed inaccuracy is above the preset upper value, the sink node reduces the size of the grid area that was defined at operation S400 (S470). The inaccuracy above the upper value implies the large difference between the data value received from the representative sensor node and the data values received from the other sensor nodes in the grid areas. Thus, the sink node determines the low data correlation and reduces the size of the grid area.

When the computed inaccuracy is below the preset upper value, the sink node enlarges the grid area of which size is defined at operation S400 (S480). The inaccuracy below the upper limit implies a small difference between the data value received from the representative sensor node and the data values received from the other sensor nodes in the grid areas. Thus, the sink node determines the high data correlation and increases the size of the grid area.

After redefining the grid area, the sink node randomly searches the sensor nodes disposed in the redefined grid area and reselects the representative sensor node (S490).

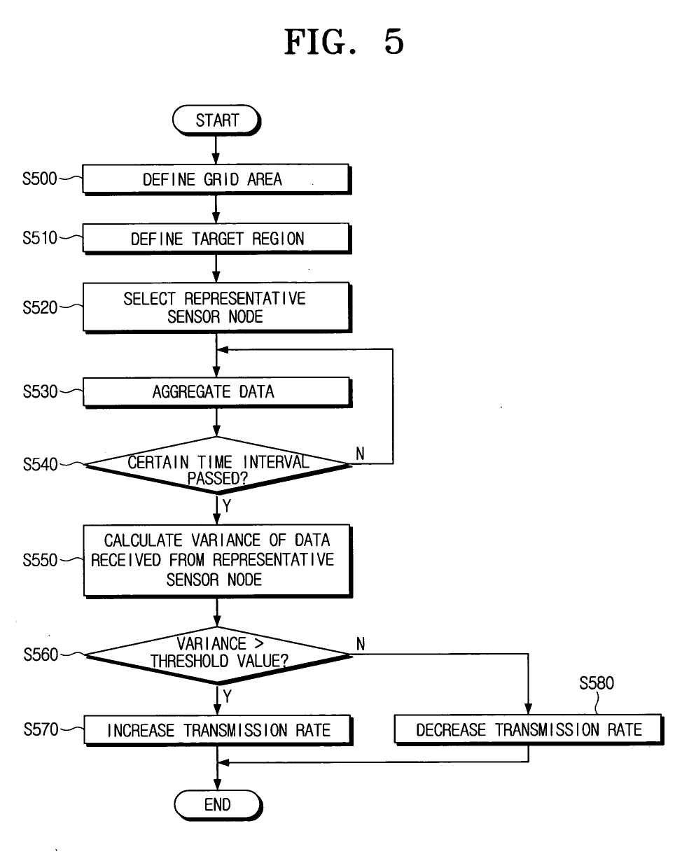

FIG. 5 is a flowchart explaining the data aggregation method according to an exemplary embodiment of the present invention.

In FIG. 5, operations S500 through S540 are the same as the operations S400 through S440 described above in reference to FIG. 4. The descriptions as to the operations S500 through S540 are omitted for sake of brevity.

After a certain time interval, the sink node calculates the variance of the data received from the representative sensor node for the certain time interval (S550). The variance of the data is presented as the standard deviation.

The sink node determines whether the computed variance exceeds a preset threshold value (S560). The threshold value is a value of data transmitted from the representative sensor node at the previous time interval.

When the calculated variance exceeds the preset threshold value, the sink node increases the transmission rate of the representative sensor node (S570). Since the standard deviation over the threshold value implies a low data correlation of the representative sensor node, the sink node increases the transmission rate of the representative sensor node.

When the calculated variance is below the preset threshold value, the sink node decreases the transmission rate of the representative sensor node (S580). Since the standard deviation below the threshold value implies a high data correlation of the representative sensor node, the sink node decreases the transmission rate of the representative sensor node.

In light of the foregoing as set forth above, according to an exemplary embodiment of the present invention, the power consumption for the data transmission over the sensor network can be reduced since the amount of the delivered data reduces and the overload is also lowered. In addition, it is possible to control the data transmission rate depending on the correlation, and the quality of the delivered data can be enhanced.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A sensor network comprising:
a representative sensor node which collects information of a grid area that includes at least two sensor nodes, and transmits the collected information of the grid area; and
a sink node which selects the representative sensor node by randomly searching the at least two sensor nodes in the grid area and aggregates the collected information of the grid area received from the representative sensor node.

2. The sensor network according to claim 1, wherein the representative sensor node is one of the at least two sensor nodes within the grid area.

3. The sensor network according to claim 1, wherein the representative sensor node transmits the collected information of the grid area to the sink node during a first time interval, and
the at least sensor nodes transmit information of the grid area to the sink node during a second time interval that is longer than the first time interval.

4. The sensor network according to claim 3, wherein the sink node computes an inaccuracy indicating a difference between the collected information received from the representative sensor node and the information received from the sensor nodes.

5. The sensor network according to claim 4, wherein the sink node redefines the grid area by comparing the inaccuracy with a preset upper limit.

6. The sensor network according to claim 5, wherein the sink node enlarges a size of the grid area if the inaccuracy is less than the preset upper limit, and
the sink node reduces the size of the grid area if the inaccuracy is greater than the preset upper limit.

7. The sensor network according to claim 5, wherein the sink node selects another representative sensor node by randomly searching sensor nodes disposed within the grid area which is redefined.

8. The sensor network according to claim 5, wherein the sink node resets a length of the first time interval by comparing a variance of the collected information received from the representative sensor node during a latest time interval with a threshold value which is a value of the collected information received from the representative sensor node during a time interval prior to the latest time interval.

9. The sensor network according to claim 8, wherein the sink node increases a length of the first time interval if the variance is less than the threshold value, and
the sink node decreases the length of the first time interval if the variance is greater than the threshold value.

10. A data aggregation method for a sensor network including a plurality of sensor nodes which collect information of a grid area, a representative sensor node which transmits the collected information of the grid area to a sink node, and the sink node for aggregating the information received from the representative sensor node, the method comprising:
defining a target region in the grid area that covers at least two sensor nodes;
selecting the representative sensor node by randomly searching the at least two sensor nodes in the grid area of the target region; and
aggregating the collected information of the grid area received from the representative sensor node.

11. The data aggregation method according to claim 10, wherein the representative sensor node is one of the at least two sensor nodes within the grid area.

12. The data aggregation method according to claim 10, wherein the representative sensor node transmits the collected information of the grid area to the sink node during a first time interval, and
the sensor nodes transmit information of the grid area to the sink node during a second time interval that is longer than the first time interval.

13. The data aggregation method according to claim 12, further comprising computing an inaccuracy that indicates a difference between the collected information received from the representative sensor node and the information received from the sensor nodes.

14. The data aggregation method according to claim 13, further comprising redefining the grid area by comparing the inaccuracy with a preset upper limit.

15. The data aggregation method according to claim 14, wherein the redefining of the grid area comprises enlarging a size of the grid area if the inaccuracy is less than the preset upper limit, and reducing the size of the grid area if the inaccuracy is greater than the preset upper limit.

16. The data aggregation method according to claim 14, further comprising selecting another representative sensor node by randomly searching sensor nodes disposed within the grid area after the grid area is redefined.

17. The data aggregation method according to claim 10, further comprising resetting the first time interval by comparing a variance of the collected information received from the representative sensor node during a latest time interval with a threshold value which is a value of information transmitted from the representative sensor node during a time interval prior to the latest time interval.

18. The data aggregation method according to claim 17, wherein the resetting of the first time interval comprises increasing a length of the first time interval if the variance is less than the threshold value, and decreasing the length of the first time interval if the variance is greater than the threshold value.
